(19) United States
(12) Patent Application Publication
(10) Pub. No.: US 2009/0248663 A1
(43) Pub. Date: Oct. 1, 2009

(54) ONLINE TARGET LOCATION DETECTION

(75) Inventors: OMPRAKASH MANIYAR, Redmond, WA (US); HONGHUA DAI, Redmond, WA (US); YING LI, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/059,687

(22) Filed: Mar. 31, 2008

(51) Int. Cl. G06F 17/30

(52) U.S. Cl. 707/5; 707/E17.014

(57) ABSTRACT

Documents are provided that are geographically relevant to a user or a request. Information describing the online activity of a user is received and location identifiers are obtained. The plurality of location identifiers provide geographic location information defining the geographic intent of the information describing the online activity of the user, the location of the computing device utilized by the user, or the user's registered geographic location. Sets of predefined rules are then applied to the received information and the plurality of location identifiers to select at least one geographic location. Documents are then returned to the user that are geographically relevant based on the selected geographic location. The received information may include search queries, and the documents may include search results and/or advertisements.

### BACKGROUND

Search engine operators often receive search queries from users, and in return provide the users with search results that are, hopefully, relevant to the user's query. The queries received from users may often be directed to finding information that is relevant to a particular geographic location. Search queries of this type are typically referred to as local searches.

In order to serve search results that are geographically relevant to a local search query, geographically relevant local search results need to be selected. This location based relevance is often called “Geo-Relevancy.” The main feature of Geo-Relevancy is accurately identifying the proper location to target for the user entering the search query. This location to target may be referred to as a “target location.” Once a target location is determined for a user entering a search query, matching methods and algorithms can be implemented to select search results that are relevant to the target location. However, current methods of determining a target location often do not provide accurate results. Other applications of determining target location for local search queries involve the presentation of targeted advertisements to the user based on their target location. Further applications involve the determining of a target location based on information describing the online activity of a user.

### SUMMARY

Embodiments of the invention are directed to methods of target location detection. Information is received describing the online activity of a user and one or more location identifiers associated with the user and/or the information. The location identifiers may be GPS information, reverse IP location information, location information extracted from web pages viewed by the user, user self reported location information, or any location identifiers that provide a geographic location associated with the user and/or search query. If the information describing the online activity of a user includes a search query, a query dominant location of the search query may be determined as well. A query dominant location is the geographic location most likely to be associated with the query, and that geographic location may be considered an additional location identifier.

A set of rules are applied to the location identifiers to determine a geographic location that is most relevant to the information describing the online activity of the user and/or the user. Documents are selected that are relevant to the geographic location. The documents may include search results and/or advertisements. The search results may include regular algorithmic based search results, as well as paid, sponsored search results. The selected documents are then provided to the user. An improved method is thereby presented of selecting geographically relevant documents for presentation to a user.

Alternative embodiments of the invention are directed to consulting a data cache to determine if a geographic location has already been determined for a location identifier. For example, a data cache may be consulted to determine if a geographic location has already been determined for an IP address. If the data cache can not provide a geographic location for the location identifier, the request is moved to a priority queue and fulfilled by consulting the appropriate location detection service. The answer is subsequently stored in the data cache and passed on to the arbitration logic unit where a set of rules are applied to the geographic location and other geographic locations in a method similar to the other embodiments of the invention.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a system diagram depicting an exemplary system for the transmission of location information and the determination of a target location;

FIG. 3 is a flow diagram showing a method for generating a response to a request for a target location identity by consulting a data cache;

FIG. 4 is a flow diagram showing a method for providing search results targeted to a user based on a geographic location according to one embodiment of the present invention;

FIG. 5 is a flow diagram showing a method for determining a target location of a search engine query in accordance with another embodiment of the present invention; and

FIG. 6 is a flow diagram showing method for obtaining a target location identity in accordance with a further embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless, and except, when the order of individual steps is explicitly described. Figures below will use like numbers when possible in order to show similarities and differences from figure to figure.

Embodiments of the present invention are directed to, among other things, providing search results targeted to a specific geographic location. In order to do this, a geographic location associated with a search query is determined. A plurality of location identifiers may be obtained. The location identifiers provide geographic location information based on, for example, reverse internet protocol lookup procedures, global positioning system (GPS) information, user self reported location information, or an analysis of past user search queries issued by a user. A set of rules is used to determine the specific location identifier(s) to utilize when selecting one or more documents to satisfy the search query in order to provide the user with the most geographically relevant search results. The set of rules may also provide that an additional location, not provided by the location identifiers, be utilized when selecting one or more documents in order to provide the user with the most geographically relevant results. Search results may then be presented to the users that are most geographically relevant to the search query because a plurality of location identifiers have been analyzed and the location(s) that are most likely relevant to the user and the search query are used in the selection of the search results. While examples are given with regards to using the target location detection to provide geographically relevant search results, other applications are available and the scope of the invention should not be construed as only relating to search queries. For instance, target location can be inferred based on the content of web pages that a user has browsed in addition to the target location provided by the user's reverse IP information. This target location can be used, for instance, in behavioral targeting or in the selection of contextual ads to display to a user.

Alternative embodiments of the invention may use the location identifiers in order to select target advertisements to present to users based on their locations. Advertisements for local businesses could be presented in conjunction with the search results or specific advertisements could be directed to a user based on their location. For example, if it is determined that the most relevant location identifier provides a geographic location of Miami, Fla., advertisements for sun tanning lotion may be provided in conjunction with the search results.

One practical application of this method involves returning geographically relevant search results in response to a search query entered by a user. For instance, if a user enters a search query such as “coffee shop”, the predefined set of rules is applied to the plurality of location identifiers in order to select at least one location identifier. The rules serve to arbitrate between the plurality of location identifiers to determine which location identifiers most likely represent the location of a coffee shop that the user is searching for. For example, if reverse IP information, GPS information, and user registered location information are provided by the plurality of location identifiers, the rules would indicate that that GPS location identifier should be selected, as it provides geographic location information that is most likely correct when compared to the other location identifiers provided.

Based on which types of location identifiers are received, different rules are applied to the selection of the location identifier. For instance, if reverse IP information and user registered location is provided, the rules may dictate that the reverse IP information be selected. Different rules may be applied based on the type of query received. Queries such as “coffee shop” are generic and do not provide any indication of an association with a geographic location. One set of rules may be defined for queries of this type. An additional set of rules may be applied to search queries that provide an indication of an association with a geographic location. Queries of this type may be “hotels near [X],” where X is a geographic location. Alternative embodiments of the invention may utilize the location X as one of the plurality of location identifiers.

In addition, the set of rules may provide that a location not provided by the location identifiers is selected. One example of this situation is where it is determined that a user is looking for a car dealership in Sammamish, Wash. This determination may be accomplished through query dominant location detection, or any other method known to those skilled in the art. While some embodiments of the invention may only return results relating to car dealerships in Sammamish, other embodiments of the invention provide for returning results relating to car dealerships located in neighboring cities. This scenario would occur if we know that there are no reputable car dealerships in Sammamish, then the target location can instead be selected from the neighboring cities of Bellevue, Wash. or Redmond, Wash. This knowledge of the reputation of car dealerships could be inferred from customer ranking websites, or any other method to determine the likelihood of finding a suitable car dealership in Sammamish. In this example, since we know that there is low likelihood of finding a reputable car dealership in Sammamish, the target location of two neighboring cities that are known to have reputable car dealerships is returned. Along these same lines, yet another example of this embodiment of the invention involves recommending a location for two friends that are going to meet to have dinner together. In this example, the two friends are located at different locations. A target location can the be recommended in between the current locations of the two friends, so that they can meet half way. Common to these two examples is the returning of a target location that is different than the locations provided by the location identifiers. A knowledge base may be consulted to determine if a target location should be returned that has not otherwise been provided by the location identifiers in order to provide the most geographically relevant location identifier.

Returning now to the “coffee shop” example discussed above, the at least one selected location identifier is then used to select search results that are relevant to the geographic location of the location identifier. In this example where GPS information is received and the query of “coffee shop” is presented, only search results relating to coffee shops near the geographic location provided by the GPS information would be returned to the user.

In other embodiments of the invention a query dominant location may be determined for each search query received. An example of a query dominant location (QDL) would be the above example query of “hotels near [X],” where location X is the QDL of the query. Other examples of query dominant locations will be provided in greater detail below. As in other embodiments of the invention, pluralities of location identifiers are obtained. At least one target location is then determined by applying a set of predetermined rule to the plurality of location identifiers, the query dominant location, and the at least one search engine query.

Alternative embodiments of the invention perform methods for determining a target location identity. A request is received for at least one location identifier, and one or more location identifiers are provided by a plurality of location detection services. The one or more location identifiers may be for example, selected from query dominant location information, reverse IP information, GPS information, and user self reporting location information. An answer is then selected by analyzing information provided from the location detection services. This answer may contain at least one geographic location identifier. A target location identity may then be determined by applying a predefined set of rules to the geographic location identifier. This determining may occur at an arbitration logic unit. The predefined sets of rules may be similar in operation to those discussed above in regards to the provided examples.

Having briefly described an overview of embodiments of the present invention, an exemplary operating environment suitable for implementing embodiments hereof is described below.

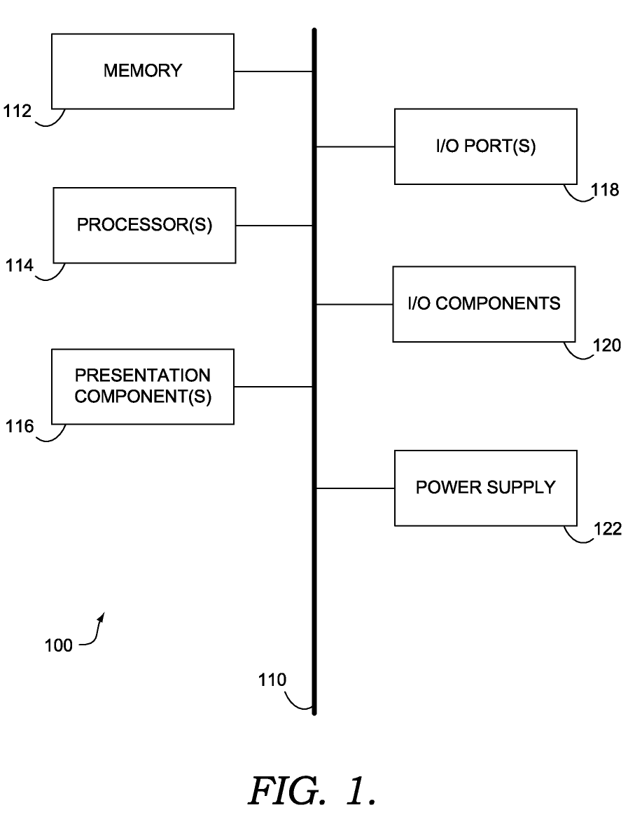

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, 1/0 modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventor recognizes that such is the nature of the art, and reiterates that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

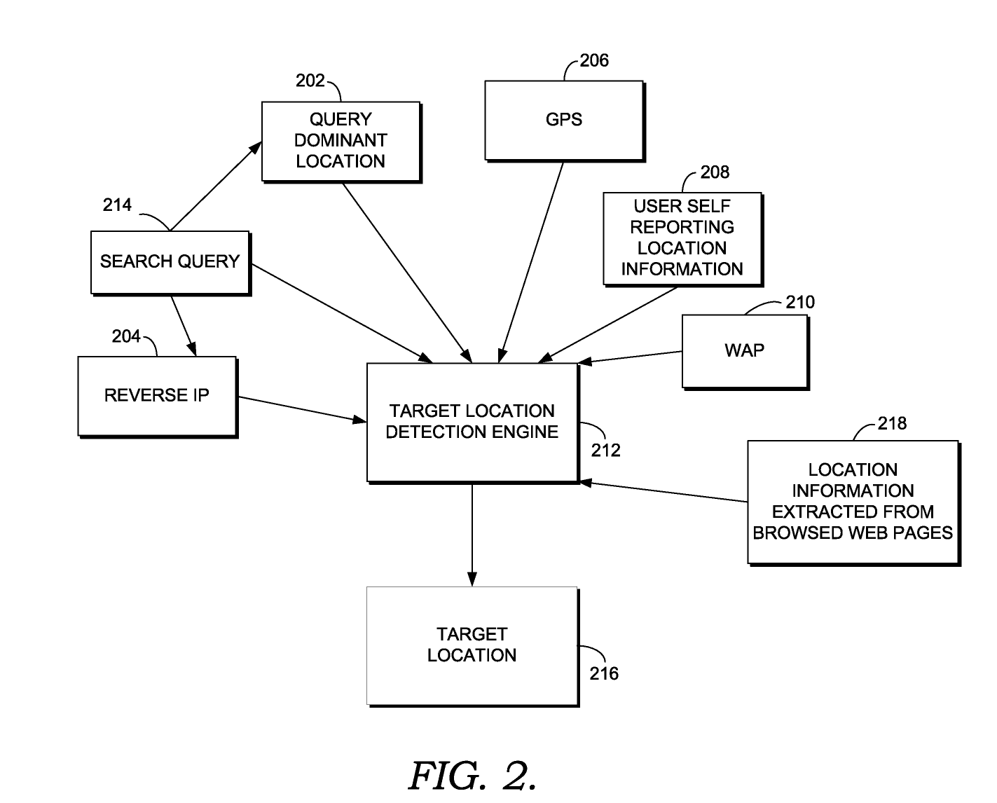

Turning now to FIG. 2, a system diagram is provided that illustrates an exemplary system for the transmission of location information and the determination of a target location. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system includes a query dominant location (QDL) detection service 202, reverse internet protocol (IP) location detection service 204, a global position system (GPS) location detection service 206, a user self reporting location detection service 208, a wireless access point (WAP) location detection service 210, and/or location information extracted from browsed web pages 218. Each of the location detection services 202, 204, 206, 208, 210, and 218 provide geographic locations, as further described below. Additional location detection services may provided, although not depicted in FIG. 2. These may include, by way of example, wireless triangulation location detection services. This type of service may detect the geographic location of a computing device using a wireless network by comparing the maximum signal strength received from the computing device at each of at least three receivers. By comparing the wireless signal strength being received at three or more locations, the location of the computing device transmitting the signal may be determined through known mathematical principles. Other location detection services that provide an indication of locations for computing devices may be used that are well known to those in the art for the purpose.

Target location detection engine (TLDE) 212 receives location information from the plurality of location detection services 202, 204, 206, 208, 210, and 218, as well as search query 214. Search query 214 may be any word or phrase that is entered by a user describing information or resources they are seeking. TLDE 212 applies sets of predetermined rules in order to select at least one geographic location provided by the plurality of location detection services 202, 204, 206, 208, 210, and 218. The selected geographic location may then be output by the TLDE 212 as a target location 216. The target location 216 is the geographic location that will be used in the selection of search results in response to the search query 214.

A more in depth description of the location detection services 202, 204, 206, 208, 210, and 218, will be provided. QDL detection service 202 determines a dominant geographic location for search query 214. For instance, a search query 214 of “hotels near Seattle” would have a dominant geographic location of Seattle. This approach may often prove most useful for search queries that contain a geographic location as part of the query. Other methods of QDL may be utilized, as known by those skilled in the art.

Reverse IP location detection service 204 operates by analyzing the IP address of a computing device being used to issue the search query 214. Through methods well known in the art, a geographic location of a computing device associated with an IP address may be determined.

GPS location detection service 206 involves the use of global positioning system (GPS) satellites transmitting radio frequency signals and a receiver to receive these signals and compute the geographic location of the receiver. The specific functionality of GPS location detection systems and their methods of operation are well known to those skilled in the art and will not be discussed in detail herein. GPS location detection service 206 may be integrated or accessible to a computing device used by a user to input a search query 214. For example, and by way of illustration only, a user may enter a search query on a wireless computing device that has a GPS location detection service 206 as part of the wireless computing device. The geographic location may then be transmitted to the TLDE 212 in conjunction with the search query 214. Users may also enter search queries on any type of computing device that has GPS location detection service 206 as part of the computing device. The geographic location provided by the GPS location detection service 206 may be provided to the TLDE 212 in conjunction with the search query 214.

The user self reporting location detection service 208 provides information about the geographic location of a user, as provided by the user. For instance, a user may provide their geographic location to a search engine or other website. This may be part of a user profile associated to a user login. Varying methods are available for user self reporting location detection services 208, as recognized by those skilled in the art. Wireless access point (WAP) location detection service 210 determines the geographic location of a computing device from which a search query 214 is entered by determining the geographic location of the wireless access point that the computing device is accessing. The computing device is then interpreted to have the same relative geographic location as the wireless access point.

Turning now to QDL detection service 202, one skilled in the art will recognize that there are a variety of communication methods that may communicatively couple location detection services 202, 204, 206, 208, 210, 218, TLDE 212, search query 214, and target location 216 including but not limited to: the internet, analog telecommunications networks, private data networks, and cellular type networks. Common to all of these networks is their ability to facilitate the transmission of data and information. Additionally, other components not shown may also be included within the system.

Referring to the location information extracted from browser web pages 218, this location information may include geographic locations extracted from the context of web pages viewed by a user. For instance, if a user has recently viewed web pages for hotels in Alexandria, Va., the extracted location information would indicate Alexandria, Va. as a geographic location. By way of further example, the information may also be extracted from web pages that a user views on a social networking web site. These web sites are well known and may include, FACEBOOK, MYSPACE, FRIENDSTER, or any other similar web site. In these instances the location information may be extracted from the profiles of different users that a user has viewed. For example, if a first user was browsing a page within a second user's profile of pictures taken in Seattle, Wash., the location information extracted from that web page may include the geographic location of Seattle, Wash. The above examples provided are merely illustrative in nature, and should not be interpreted to be limiting. Location information may extracted from any type of web page viewed by a user.

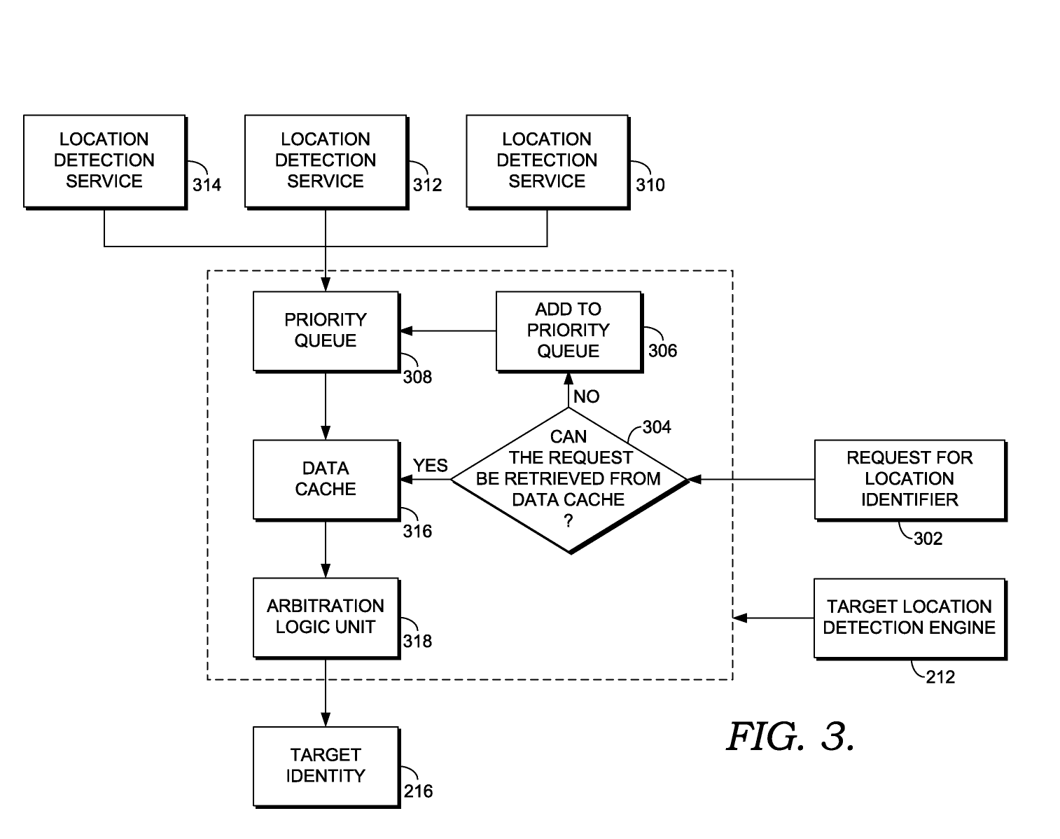

Turning now to the TLDE 212, the sets of predetermined rules will be more thoroughly discussed. Although not shown in FIG. 2, the TLDE 212 contains an arbitration logic unit 318, as shown in FIG. 3. The arbitration logic unit 318 applies sets of predetermined rules to the geographic information received from the location detection services 202, 204, 206, 208, 210, and 218. The arbitration logic unit 318 may be integral to the TLDE 212 or it may be a separate component. The predetermined sets of rules define which geographic location received from the location detection services 202, 204, 206, 208, 210, and 218 should be output as the target location 216. In certain instances, more than one geographic location may be output as the target location 216.

It should be understood that the sets of rules recited below are presented as examples only, and that differing standards and criteria could be applied to the selection of a geographic locations as a target location. Common to all of the rules is the goal of providing the most geographically relevant target location 216 to associate with a search query and/or information describing the online activity of a user by applying a set of rules to different location information that is available to the arbitration logic unit 318 and TLDE 212. Different rules may then be implemented to achieve this goal, and the rules presented below are intended to be merely illustrative. As a whole, the sets of rules may be referred to as an arbitration logic table.

The first set of rules deal with search queries and/or information describing the online activities of a user that do not provide an indication of geographic location that they are associated with. Examples of these types of search queries are “coffee shop” or “shoe store.” Common to this type of query is geographic ambiguity, as a geographic location of the “coffee shop” or “shoe store” is not provided. These types of queries do lend themselves to the determination of query dominant location. Therefore this set of rules does not provide for the input of this type of location information.

There may be instances where only one location detection service is obtained by the TLDE 212. In these instances, the target location 216 will obviously be determined to be the geographic location provided by the obtained location detection service. If reverse IP and user self reporting location information are provided to the arbitration logic unit 318, it will output the target location 216 as being the geographic location provided by the reverse IP information. This is the case because the reverse IP location information likely provides a more accurate geographical location associated with the search query.

If reverse IP, GPS, and user self reporting location information are provided to the arbitration logic unit 318, the geographic location provided by the GPS location information will be returned as the target location 216. The GPS location information is returned as the target location 216 as there is a high probability that it accurately defines a geographical location associated with the search query.

The second set of predefined rules are utilized for queries and/or information describing the online activities of a user that provide an indication of geographic intent, such as “hotels near Seattle” or “restaurants in Alexandria, Va.” For queries of this type, location information provided by QDL is considered as well.

In situations where QDL, reverse IP, and user registered location information is provided to the arbitration logic unit 318, the geographic location provided by the QDL information will be returned as the target location 216 if the distance between the geographic locations provided by the QDL and the reverse IP is significant. The definition of a significant distance could be defined by a user, or it may be set as a standard distance of some number of miles. In the alternative, if the distance between the geographic locations is not significant, both geographic locations may be returned as the target location 216.

Given a scenario where QDL, GPS, reverse IP, and user registered location information is provided to the arbitration logic unit 318, the geographic location provided by the QDL information will be returned as the target location 216 if the distance between the geographic locations provided by the QDL and the GPS is significant. The definition of a significant distance could be defined by a user, or it may alternatively be set as a standard distance of some number of miles. In the alternative, if the distance between the geographic locations is not significant, both geographic locations may be returned as the target location 216.

Where QDL and user registered location information is provided to the arbitration logic unit 318, the geographic location provided by the QDL information will be returned as the target location 216 if the distance between the geographic locations provided by the QDL and user self reported location information is significant. The explanation of what constitutes a significant distance would be similar as that described above. However, if the distance between the geographic locations is not significant, both geographic locations may be returned as the target location 216.

Common to all scenarios that return multiple geographic locations as the target location 216 is the possibility that the user may travel between the multiple geographic locations, and hence both locations should be output as the target location 216.

Turning now to FIG. 3, a flow diagram is provided illustrating a method for generating a response to a request for target location identification by consulting a data cache in accordance with one embodiment of the present invention

In this embodiment, the method begins at block 302 with the request for a location identifier. Although the request is depicted in FIG. 3 as coming from outside the TLDE 212, the request may actually be generated in the TLDE 212 in response to a search query. A location identifier may be the geographic location provided by one of the location detection services 202, 204, 206, 208, 210, and 218 as described in reference to FIG. 2 or the location detection services 314, 312, and 310 as depicted in FIG. 3. For the remainder of the discussion with regards to FIG. 3, only location detection services 310, 312, and 314 will be referenced, although it should be understood that these location detection services are equivalent to the location detection services depicted in FIG. 2. This embodiment of the present invention addresses situations where there may be a significant latency or response time encountered in obtaining geographic information from the location detection services 314, 312, and 310. It is therefore desirable to store location detection information in a data cache 316, so that common requests may quickly and efficiently be answered.

After a request for a location identifier 302 is received by the TLDE 212 a determination is made at block 304 of whether the request can be retrieved from the data cache 316. If the request can be retrieved from the data cache 316, the location identifier is then passed to the arbitration logic unit 318. The predefined sets of rules are then applied at the arbitration logic unit 318 as discussed above in reference to FIG. 2, and a target location 216 is output from the TLDE 212.

If it is determined that the request can not be retrieved from the data cache at block 304, the request is then added to a priority queue at block 306. A priority queue 308 is in effect a queue of location identifiers that are waiting to be retrieved from the location detection services 310, 312, and 314. The priority queue 308 may contain a plurality of requests for location identifiers, and may be sorted such that higher priority requests for location identifiers are processed before lower priority requests. The priority of the requests for location identifiers may be determined by the frequency of request. Alternative embodiments may use any suitable method for ranking the priority of the requests based on any number of criteria.

Once a request for a location identifier has been processed in the priority queue 308 and the requested location identifier is received from the location detection services 310, 312, and 314, the requested location identifier is stored in the data cache 316 before being passed on to the arbitration logic unit 318. The predefined sets of rules are then applied at the arbitration logic unit 318 as discussed above in reference to FIG. 2, and a target location 216 is output from the TLDE 212.

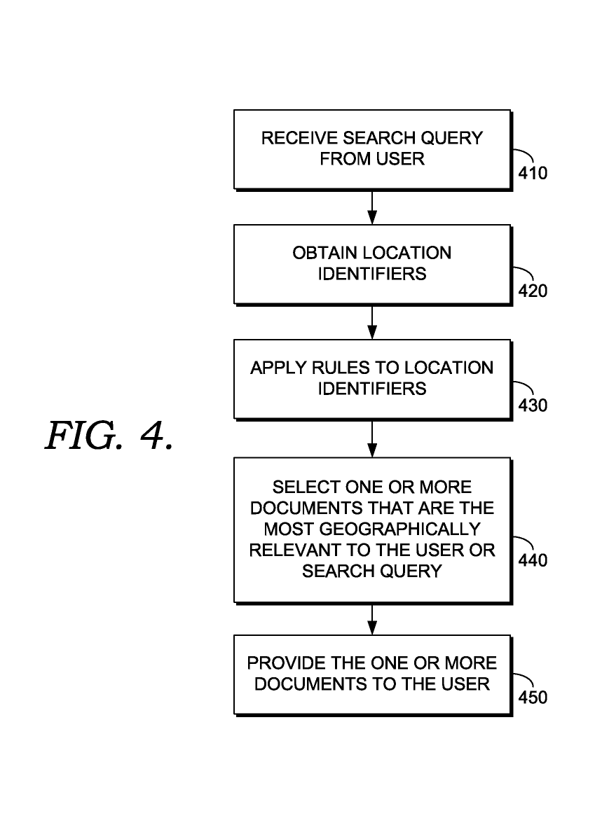

Turning now to FIG. 4, a flow diagram showing a method for providing search results targeted to a user based on a geographic location is depicted according to one embodiment of the invention. In this embodiment, the method begins at block 410 where a search query is received from a user. The search query may be entered by the user into any type of computing device. In some embodiments of the invention, the search query is transmitted to the TLDE (212). While FIG. 4 generally depicts receiving a search query from user in block 410, it should be understood that the method shown in FIG. 4 is not limited to search queries. Rather, in alternative embodiments of the invention a request for a web page may be received in block 410, instead of or in addition to a received search query. Indeed, any information relating to a user's online activity may received in block 410. This information, by way of illustration only, may include web pages that a user has requested. This example is not intended to be limiting. Ones skilled in the art will recognize that any information relating to a user's online activity may encompass many different scenarios.

Turning back to the embodiment of the invention relating to the receiving of a search query in block 410, a plurality of location identifiers is obtained at block 420. The plurality of location identifiers may be the same or similar to the plurality of location identifiers discussed in relation to FIG. 2, above. Common to the plurality of location identifiers is the ability to provide geographic location information. For instance, a GPS location identifier provides geographic location information by analyzing radio frequency signals received from a plurality of satellites. A GPS receiver, as known in the art in some embodiments of the invention may be integrated into the computing device used to transmit the search query. This embodiment provides the GPS location information along with the search query to the TLDE. Other embodiments of the invention may use different location identifiers, as described above in relation to FIG. 2.

A query dominant location (QDL) identification service provides geographic location information by analyzing the content of the search query for an indication of a geographic intent. For example, given the search query “hotels near Seattle,” Seattle would be the geographic location returned by the QDL identification service. Additional location identifiers may be obtained as well, such as those described in relation to FIG. 2, above.

In block 430, a set of predefined rules are applied to the plurality of location identifiers to select at least one location identifiers. These sets of predefined rules serve to arbitrate between the plurality of obtained to location identifiers in order to select at least one location identifier. The geographic location(s) of the at least one location identifier are then passed on as a target location, as described in FIGS. 2 and 3. The predefined sets of rules provide different criteria to use in selecting location identifiers based on which specific location identifiers are obtained and the type of query received. Exemplary embodiments of the invention employing these rules are described in relation to FIG. 2.

At block 440, one or more documents are selected to satisfy the search query received in block 410 that are the most geographically relevant to the user or the search query. Although, not depicted in the figure the geographic location provided by the at least one selected location identifier is used in selecting the documents to satisfy the search query. Search results are selected that are the most geographically relevant to the provided geographic location. For instance, if the provided geographic location is “Alexandria, Va.,” and the search query is “Italian restaurant,” search results will be selected for websites of Italian restaurants located in Alexandria, Va. In this manner, search results are provided to a user that are geographically relevant.

In block 450 the one or more selected documents are provided to the user. In one embodiment of the invention, the one or more selected documents are provided to the user in the form of search results generated in response to the search received from the user. In the above example for Italian restaurants, a listing of the websites associated with Italian restaurants in Alexandria, Va. would be provided to the user. The search results may also contain ancillary websites that a user would realize are related to Italian restaurants in Alexandria, Va., such as restaurant review websites or restaurant guide websites. While FIG. 4 refers to the selection of documents, alternative embodiments of the invention may return advertisements targeted to a user that are geographically relevant to the user. For instance, if the provided geographic location is “Alexandria, Va,” and the search query is “Italian restaurant,” advertisements may be displayed to the user for Italian restaurants near Alexandria, Va.

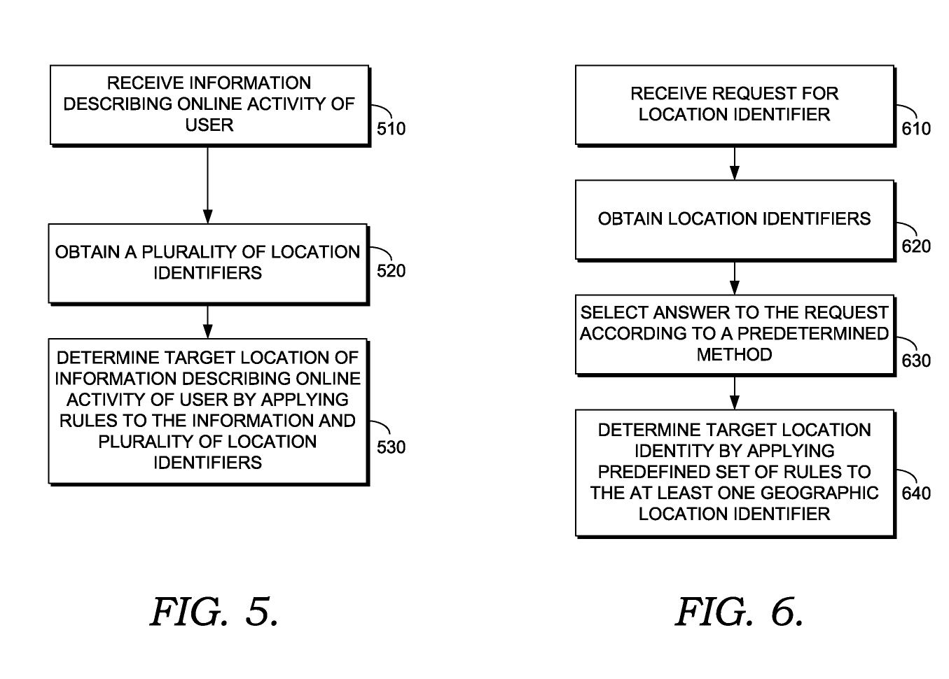

Turning to FIG. 5, a flow diagram showing a method for determining a target location of information describing the online activity of a user according to an alternative embodiment of the invention is presented. The method begins at step 510 with receipt of information describing online activity of a user. This may include many different types of information, including but not limited to search queries entered by a user, requests for web pages entered received from a user, information relating to online shopping activity of a user, or any other information that describes the online activity of a user. For instance, this information may include a social networking web site that a user is visiting. If the information comprises a search query, the search query may be entered by a user into any type of computing device.

Although not depicted in FIG. 5, if the received information is a search query, an additional step occurs after block 510. At this step, a determination is made of a query dominant location (QDL) for the received search query. As discussed above, given a search query such as “Italian restaurants near Alexandria, Va.,” the QDL would be Alexandria, Va. This is but one example of the QDL, and there are other methods known in the art for determining the QDL of a search query.

A plurality of location identifiers are obtained in block 520. The plurality of location identifiers obtained in block 520 are similar to those obtained in FIGS. 2 and 4, as discussed above. At block 530, at least one target location is determined for the received information describing the online activity of the user by applying a set of predefined rules to the plurality of location identifiers and the received information. The set of rules applied in block 530 are similar to those applied in FIGS. 2, 3, and 4, as recited in the discussion of those FIGS.

In embodiments of the invention where the received information comprises a search query received from the user, the step of determining a target location in block 530 further comprises applying the to the search query and the query dominant location, in addition to the plurality of location identifiers.

Turning now to FIG. 6, a flow diagram depicting a method for obtaining a target location identity according to another embodiment of the invention is provided. The method begins at block 610 by receiving a request for location identifiers. This request for the location identifier may be issued, for example, by the target location detection engine in response to the reception of a search query. In some embodiments of the invention, a request may be made for all of the available location identifiers. A plurality of location identifiers are obtained at block 620. The plurality of location identifiers may include query dominant location information, reverse IP location information, GPS location information, and user self reporting location information. In block 630 an answer to the request is selected by analyzing information provided from the plurality of location detection services, wherein the answer contains at least one geographic location identifier. According to some embodiments of the invention, multiple geographic locations may be provided as an answer to the request if multiple location identifiers are available. Although not explicitly depicted in the figure, in some embodiments of the invention multiple requests for location identifiers may be received at block 610, and therefore multiple location identifiers may be obtained at block 620, and subsequently provided to block 640. At block 640, a target location is determined by applying sets of predefined rules to the at least one geographic location identifier where determining occurs at an arbitration logic unit. The sets of predefined rules may be similar to those described in relation to FIGS. 2, 3, 4, and 5 above.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A method of providing search results targeted to a user based on their location, the method comprising:
receiving at least one search query from a user;
obtaining a plurality of location identifiers associated with the user;
applying a set of rules to the plurality of location identifiers to select at least one location identifier;
selecting one or more documents to satisfy the search query that are the most geographically relevant to the user or the at least one search query; and
providing the one or more selected documents to the user.

2. The method of claim 1, wherein the plurality of location identifiers associated with the user define geographic locations associated with the user.

3. The method of claim 2, wherein the obtained plurality of location identifiers comprise one or more of the following:
global positioning system (GPS) information, reverse internet protocol (IP) address information, query dominant location information, user self reported location information, and locations detected from wireless access point locations.

4. The method of claim 3, wherein the GPS information is provided by a device used by the user to transmit the search query.

5. The method of claim 3, wherein the reverse IP information provides the geographic location of a computing device based on IP address of the computing device.

6. The method of claim 3, wherein the query dominant location information is ascertained by analyzing the content of a search query in order to determine the geographic location that is most relevant to the search query.

7. The method of claim 3, wherein the locations detected from wireless access point locations comprise location information for the geographic location of the wireless access point utilized by a computing device used by the user to transmit the at least one search query.

8. The method of claim 1, wherein the rules applied to the plurality of location identifiers define different scenarios for the selection of the at least one location identifier based on the type of search query received.

9. The method of claim 8, wherein for each type of search query received, multiple rules are defined and applied based on the specific plurality of location identifiers obtained.

10. The method of claim 1, wherein the one or more selected documents are provided to the user through a list of search query results.

11. One or more computer-readable media having computer-executable instructions embodied thereon that, when executed, perform a method for determining a target location of information describing the online activity of a user, the method comprising:
receiving information describing the online activity of a user;
obtaining a plurality of location identifiers; and
determining at least one target location for the information describing the online activity of a user by applying of a set of predetermined rules to the plurality of location identifiers and the information describing the online activity of a user.

12. The method of claim 11, wherein the information describing the online activity of the user includes at least one search query and a corresponding query dominant location of the at least one search engine query is determined by analyzing the content of the at least one search query in order to find the geographic location that is most relevant to the at least one search engine query.

13. The method of claim 11, wherein the plurality of location identifiers define geographic locations associated with the user.

14. The method of claim 13, wherein the obtained plurality of location identifiers comprise one or more of the following:
global positioning system (GPS) information, reverse internet protocol (IP) address information, user self reported location information, location information extracted from web pages browsed by the user, and locations detected from wireless access point locations.

15. The method of claim 12, wherein the set of predetermined rules applied to determine the at least one target location comprises an arbitration logic table.

16. The method of claim 15, wherein the arbitration logic table provides at least one target location for each type of search query and the corresponding obtained location identifiers for the search query.

17. One or more computer-readable media having computer-executable instructions embodied thereon that, when executed, perform a method of determining a target location identity, the method comprising:
receiving a request for at least one location identifier;
obtaining one or more location identifiers provided by a plurality of location detection services, the one or more location identifiers selected from the list comprising: query dominant location information, reverse IP information, global positioning system information, and user self reporting location information;
selecting an answer to the request by analyzing information provided from the plurality of location detection services, wherein the answer contains at least one geographic location identifier;
determining a target location identity by applying a predefined set of rules to the at least one geographic location identifier, wherein the determining occurs at an arbitration logic unit.

18. The method of claim 17, wherein the method further comprises analyzing a data cache to determine if an answer to the request has been previously generated.

19. The method of claim 18, wherein if an answer to the request has been previously generated, retrieving the answer from the data cache and routing the answer to the arbitration logic unit, wherein the answer contains at least one geographic location identifier.

20. The method of claim 17, wherein if an answer to the request has not been previously generated, routing the request for the at least one location identifier to a priority queue, obtaining information from a corresponding location detection service, storing the answer in the data cache, and routing the answer to the arbitration logic unit.
